(19) United States
(12) Patent Application Publication
(10) Pub. No.: US 2026/0014721 A1
(43) Pub. Date: Jan. 15, 2026

(54) RAZOR HANDLE AND RAZOR ASSEMBLY COMPRISING SAME

(71) Applicant: DORCO CO., LTD., Seoul (KR)

(72) Inventors: Sung Hee SON, Seoul (KR); Jun Soo CHANG, Seoul (KR); Jong Jin JEONG, Seoul (KR)

(21) Appl. No.: 19/337,039

(22) Filed: Sep. 23, 2025

Related U.S. Application Data
(63) Continuation of application No. PCT/KR2024/003955, filed on Mar. 28, 2024.

(30) Foreign Application Priority Data
Mar. 28, 2023 (KR) 10-2023-0040806
May 26, 2023 (KR) 10-2023-0068696
Jul. 21, 2023 (KR) 10-2023-0095160

(51) Int. Cl. B26B 21/52; B26B 21/22

(52) U.S. Cl. CPC B26B 21/521; B26B 21/225

(57) ABSTRACT

A razor handle coupling with a razor cartridge may include a head portion coupled to the razor cartridge. The razor handle may also include a grip portion extending from the head portion. The head portion may include a plunger that provides a restoring force to elastically support the razor cartridge and restore the razor cartridge to a neutral position. An indicator may be provided on an outer surface of the plunger to indicate at least one of a mounting state and a pivoting state of the razor cartridge.

### CROSS REFERENCE TO RELATED APPLICATIONS

This is a continuation application of International Patent Application No. PCT/KR2024/003955 filed on Mar. 28, 2024, which claims priority to Korean patent application No. 10-2023-0040806 filed on Mar. 28, 2023, Korean patent application No. 10-2023-0068696 filed on May 26, 2023, and Korean patent application No. 10-2023-0095160 filed on Jul. 21, 2023, contents of each of which are incorporated herein by reference in their entireties.

### BACKGROUND

### Technical Field

The disclosure relates to a razor handle and a razor assembly including the same, and more particularly to a razor handle with a plunger, and a razor assembly including the same.

### Description of Related Technology

In general, a razor refers to a product for cutting body hair such as fuzz and beard on a face or body, and includes a razor handle for gripping, and a razor cartridge with a razor blade that comes into contact with skin to have a shave.

### SUMMARY

One aspect is a razor handle and a razor assembly, in which the coupled state between the razor handle and a razor cartridge is easily recognized.

The aspects of the disclosure are not limited to those described herein, and other aspects not mentioned herein may become apparent to those skilled in the art from the following description.

Another aspect is a razor handle coupling with a razor cartridge that includes: a head portion coupled to the razor cartridge; and a grip portion extending from the head portion, wherein he head portion includes a plunger that provides a restoring force to elastically support the razor cartridge and restore the razor cartridge to a neutral position, an indicator is provided on an outer surface of the plunger to indicate at least one of a mounting state and a pivoting state of the razor cartridge.

Another aspect is a razor assembly that includes: a razor cartridge with at least one razor blade accommodated therein, and a razor handle coupling with the razor cartridge, wherein the razor handle includes a plunger that provides a restoring force to elastically support the razor cartridge and restore the razor cartridge to a neutral position, a first indicator is provided on an outer surface of the plunger, and the razor cartridge includes a second indicator at least partially overlapping the first indicator while being coupled to the razor handle.

Other details of the disclosure are included in the detailed description and the accompanying drawings.

According to the embodiments of the disclosure, the effects are at least as follows.

According to the disclosure, it is easy to check whether a razor handle and a razor cartridge are coupled.

According to the disclosure, it is easy to check whether the razor handle and the razor cartridge are perfectly aligned and coupled without misalignment.

According to the disclosure, it is easy to check how far the razor cartridge is pivoted from a neutral position.

According to the disclosure, it is easy to mount the razor cartridge to the razor handle.

The effects of the disclosure are not limited to those described above, and various other effects are included in the foregoing description.

### BRIEF DESCRIPTION OF THE DRAWINGS

FIG. 1 is a perspective view showing a coupled state between a razor handle and a razor cartridge according to an embodiment of the disclosure.

FIG. 2 is a bottom view showing a separated state of a razor handle according to an embodiment of the disclosure.

FIG. 3 is a bottom view showing a coupled state of a razor handle according to the disclosure.

FIG. 4 is a bottom view showing a slightly pivoting state of a razor handle according to an embodiment of the disclosure.

FIG. 5 is a bottom view showing a further pivoting state than that of FIG. 4.

FIG. 6 is a bottom view showing a fully pivoting state of a razor handle according to an embodiment of the disclosure.

FIG. 7 is a cross-sectional view of a head portion of a razor handle according to an embodiment of the disclosure.

FIG. 8 is a bottom view showing an alternative embodiment of an indicator in FIG. 2.

FIG. 9 is a bottom view showing a coupled state of the razor handle of FIG. 8.

FIG. 10 is a bottom view showing a coupled state different from that of FIG. 9.

FIG. 11 is a bottom view showing a misalignment-coupled state between the razor handle and the razor cartridge of FIG. 8.

FIG. 12 is a bottom view showing a separated state of a razor assembly according to another embodiment of the disclosure.

FIG. 13 is a bottom view showing a coupled state of a razor assembly according to another embodiment of the disclosure.

FIG. 14 is a bottom view showing a coupled state or a razor handle according to still another embodiment of the disclosure.

FIG. 15 is a bottom view showing a pivoting state of a second plunger of FIG. 14.

FIG. 16 is a bottom view showing a pivoting state at an angle different from that of FIG. 15.

### DETAILED DESCRIPTION

To make the razor cartridge come into close contact with a user's skin along the curvy contours of the skin, the razor cartridge is pivotally coupled to the razor handle.

When the razor handle and the razor cartridge are perfectly aligned and coupled with each other without misalignment, the razor cartridge is stably pivoted relative to the razor handle, thereby efficiently cutting a user's body hair. On the other hand, when the razor handle and the razor cartridge are misaligned and imperfectly coupled, the razor cartridge may be easily separated from the razor handle by a small impact or external force or may be unstably pivoted in that state.

If a user recognizes the misalignment-coupled state between the razor handle and the razor cartridge, s/he can use the razor after separating the razor handle and the razor cartridge and aligning and coupling them.

On the other hand, if a user shaves without recognizing the misalignment-coupled state between the razor handle and the razor cartridge, the unstable pivot of the razor cartridge may cause the body hair not to be cut efficiently or her/him to be injured by the razor blade.

The advantages and characteristics of the disclosure and a method for achieving the advantages and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Below, a razor handle and a razor assembly including the same according to embodiment of the disclosure will be described with reference to the accompanying drawings.

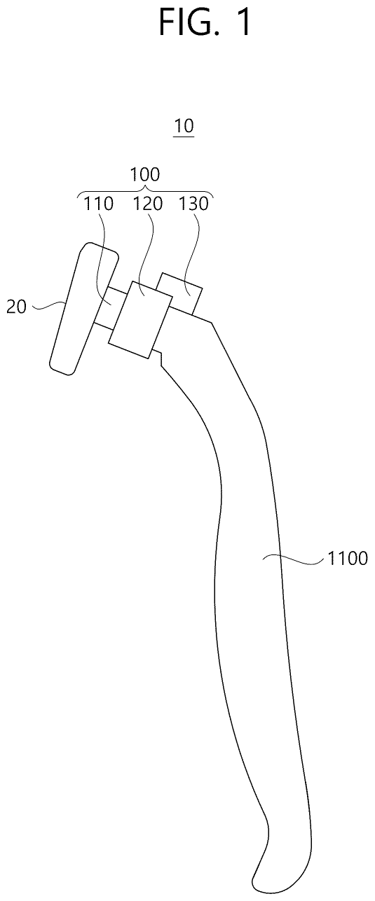

FIG. 1 is a perspective view showing a coupled state between a razor handle and a razor cartridge according to an embodiment of the disclosure.

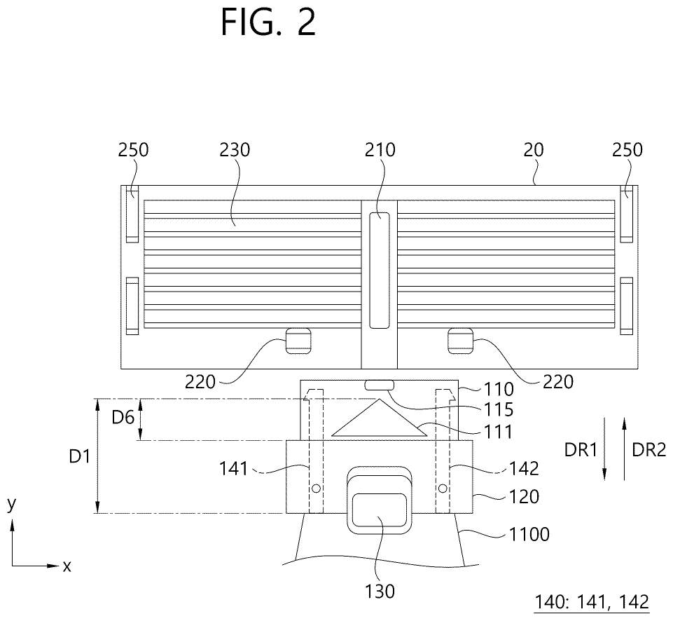

Referring to FIG. 1, a razor handle 10 an embodiment of the disclosure couples with a razor cartridge 20, and includes a grip portion 1100 and a head portion 100. The grip portion 1100 refers to a portion to be gripped by a user, and forms the body of the razor handle 10. The head portion 100 refers to a portion that pivotally supports the razor cartridge 20 (see FIG. 2) and detachably couples with the razor cartridge 20.

FIG. 2 is a bottom view showing a separated state of a mounting state of a razor handle according to an embodiment of the disclosure.

The razor handle 10 may couple with the razor cartridge 20. First, the razor cartridge 20 will be described.

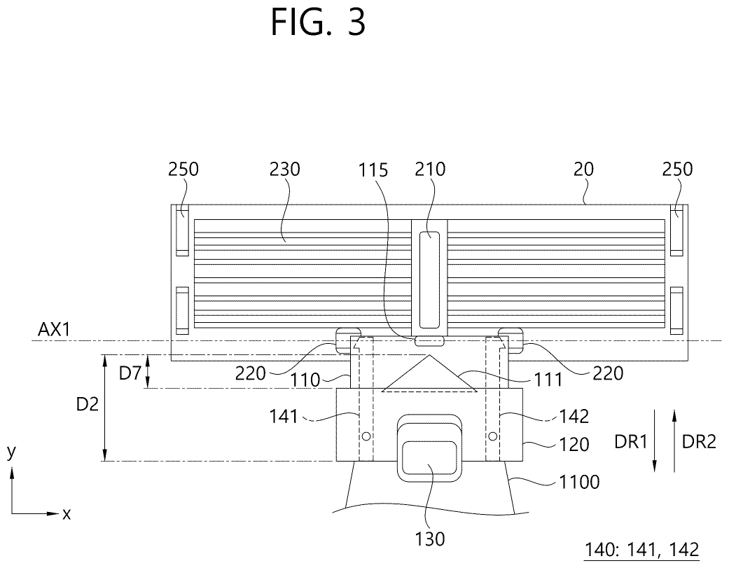

The razor cartridge 20 may accommodate at least one razor blade 230 therein. The razor cartridge 20 may include a cam 210 to be in contact with a cam contact portion 115 of a plunger 110 (to be described later), a connector 220 to couple with a cartridge coupling portion 140 of the head portion 100 (to be described later), a clip 250 to hold the razor blades, a lubrication band (not shown) to apply lubricant to skin, and a guard (not shown) to come into close-contact with a user's skin and pull the skin. The razor cartridge 20 may be pivoted around a first rotation axis AX1 (see FIG. 3) with respect to the razor handle 10. The first rotation axis AX1 refers to an axis that passes through the connector 220 in a longitudinal direction, and may be a fixed axis or an axis that is movable within a certain range. The longitudinal direction refers to the lengthwise direction of the razor cartridge 20, and is parallel to the x-axis in the accompanying drawings. A transverse direction refers to the widthwise direction of the razor cartridge 20, is perpendicular to the longitudinal direction (i.e., the x-axial direction), and is parallel to the y-axial direction in the accompanying drawings.

The grip portion 1100 refers to a portion to be gripped by a user. The grip portion 1100 may be connected to the head portion 100

The head portion 100 refers to a portion to which the razor cartridge 20 is coupled, and may pivotably support the coupled razor cartridge 20. The head portion 100 may detachably couple with the razor cartridge 20 and pivotably support the razor cartridge 20 within a certain angle range with respect to the first rotation axis AX1. The head portion 100 may include the plunger 110, a plunger housing 120, the cartridge coupling portion 140, and an operation unit 130.

The plunger 110 may provide a restoring force to elastically support the razor cartridge 20 and restore the razor cartridge 20 to a neutral position. The plunger 110 may be supported by an elastic member (not shown) to provide the restoring force. The plunger 110 may include the cam contact portion 115 to come into contact with the cam 210 of the razor cartridge 20. The cam contact portion 115 may be shaped to interact with the shape of the cam 210, thereby defining a pivot motion of the razor cartridge 20 relative to the razor handle 10. The cam contact portion 115 may be formed at a position corresponding to the position of the cam 210. When the cam 210 is formed adjacent to the central portion on the lower surface of the razor cartridge 20, the cam contact portion 115 may be formed adjacent to the central portion on the outer surface of the plunger 110. The cam contact portion 115 may be formed to have an engraved or embossed shape on the outer surface of the plunger 110, or may be formed on the same plane as the outer surface of the plunger 110.

The plunger 110 may slide in a first direction DR1 as the razor cartridge 20 pivots. The first direction DR1 refers to a direction from the razor cartridge 20 toward the head portion 100. The plunger 110 moved sliding in the first direction DR1 is supported by the elastic member, thereby providing the restoring force to restore the razor cartridge 20 to the neutral position in a second direction DR2 opposite to the first direction DR1. The plunger 110 may provide the restoring force to the razor cartridge 20 in the second direction DR2 at the same time when sliding in the first direction DR1 as the razor cartridge 20 pivots.

The plunger 110 may be shaped to be slidably supported by the plunger housing 120. The shape of the plunger 110 to be slidably supported by the plunger housing 120 will be described later in the description of the plunger housing 120.

The indicator 111 may be provided on the outer surface of the plunger 110. The outer surface of the plunger 110 refers to a surface facing the same space as the lower surface of the razor cartridge 20, and may be at least partially exposed to the outside together with the lower surface of the razor cartridge 20 when the lower surface of the razor cartridge 20 is viewed. The outer surface of the plunger 110 may be formed to have a predetermined area so that a user can easily check the indicator 111. For example, the indicator 111 may be formed to have a length in the longitudinal direction (i.e., the x-axial direction), which is longer than the length of the cam 210 in the longitudinal direction (i.e., the x-axial direction).

Further, in the state that the cartridge coupling portion 140 is coupled to the connector 220, a ratio of the width of the plunger 110 in the longitudinal direction to the outermost distance between the outermost surface of a second end of a first arm 141 in the longitudinal direction and the outermost surface of a second end of a second arm 142 in the longitudinal direction may be 0.8 to 1.2.

The plunger 110 may be elongate in the longitudinal direction (i.e., the x-axial direction) in which the razor blade 230 of the razor cartridge 20 extends, and may be disposed over a considerable portion of the length of the razor cartridge 20 in the longitudinal direction (i.e., the x-axial direction). Therefore, the outer surface of the plunger 110 according to the disclosure may have a larger area than that of the conventional plunger. Accordingly, the indicator 111 having a relatively large size and area, which can be easily recognized by a user's naked eye, may be provided on the outer surface of the plunger 110.

The indicator 111 is to indicate at least one of the mounting state and pivoting state of the razor cartridge 20, and may be provided on the outer surface of the plunger 110. The indicator 111 may be provided on the outer surface of the plunger 110 in various forms such as an engraved form, an embossed form, a sticker, and a stamp. The indicator 111 may be formed in various shapes such as a line, a circle, and a polygon, which can be recognized by a user, and the shape is not limited. Further, the indicator 111 may be formed to have a color different from that of the outer surface of the plunger 110.

The exposed area, shape, position, etc. of the indicator 111 may vary depending on the mounting state and pivoting state of the razor cartridge 20, and thus the indicator 111 may indicate the mounting state and pivoting state of the razor cartridge 20.

First, the mounting state and pivoting state of the razor cartridge 20 will be defined. The mounting state refers to a state of whether the razor cartridge 20 is mounted to the razor handle 10. The mounting state may include a separated state and a coupled state. The separated state of the mounting state refers to a state in which the razor cartridge 20 is not coupled to the razor handle 10, and the coupled state refers to a state in which the razor cartridge 20 is coupled to the razor handle 10. Specifically, the coupled state refers to a state in which the razor cartridge 20 is coupled to the razor handle 10 without applying separate external force thereto.

The pivoting state refers to a state in which the razor cartridge 20 is pivoted around the first rotation axis AX1 within a certain angle range while being coupled to the razor handle 10. The pivoting state may include a neutral state, a fully pivoted state, and a partially pivoted state.

The neutral state refers to a state in which no separate external force is applied to the razor cartridge 20 or the pivoted razor cartridge 20 is restored to the neutral position by the plunger 110 providing the restoring force, the fully pivoted state refers to a state in which the razor cartridge 20 is pivoted to a maximum angle from the neutral position, and the partially pivoted state refers to a state in which the razor cartridge 20 is pivoted to less than the maximum angle from the neutral position. The neutral state of the pivoting state and the coupled state of the mounting state refer to the neutral position of the razor cartridge 20, but for convenience of description, the neutral positions under the pivoting state and the mounting state will be referred to as the neutral state and the coupled state, respectively.

FIG. 3 is a bottom view showing the coupled state of the razor handle according to the disclosure.

Referring to FIGS. 2 and 3, the separated state and the coupled state of the razor cartridge 20 are different in the area of the indicator 111 exposed to the outside. For example, while the area of the indicator 111 may be fully exposed in the separated state, the area of the indicator 111 may be partially exposed to the outside in the coupled state.

According to an alternative embodiment, even in the separated state, a part of the indicator 111 may be placed inside the plunger housing 120 and the other part of the indicator 111 may be exposed to the outside like the example shown in FIG. 3. In this case, the area of the indicator 111 exposed to the outside in the coupled state may also be smaller than the area of the indicator 111 exposed to the outside in the separated state.

Ultimately, depending on the area of the indicator 111 exposed to the outside, it is possible to distinguish between the separated state and the coupled state of the razor cartridge 20.

Further, in the separated state and the coupled state of the razor cartridge, at least a portion of the indicator exposed to the outside may be different from each other. For example, referring to FIGS. 2 and 3, the portion of the indicator exposed to the outside may vary depending on the separated and coupled states of the razor cartridge 20 in such a manner that the indicator 111 is fully exposed in the separated state and partially exposed in the coupled state.

According to an alternative embodiment, even in the separated state, a part of the indicator 111 may be placed inside the plunger housing 120 and the other part of the indicator 111 may be exposed to the outside like the example shown in FIG. 3. In this case, a portion of the part of the indicator 111 exposed to the outside in the separated state may also be not exposed to the outside in the coupled state.

According to an alternative embodiment, the indicator 111 may be expressed to be visually clearly distinguished between the part exposed to the outside in the separated state and the part not exposed to the outside in the coupled state. For example, the corresponding part may be different in shape and/or color from the other part.

A user can distinguish between the separated state and the coupled state based on the whole or part of the exposed indicator 111.

Further, how far a front-end portion of the indicator 111 is adjacent to the grip portion 1100 may vary depending on the separated and coupled states of the razor cartridge 20. The front-end portion of the indicator 111 refers to an end portion of the indicator 111 facing the razor cartridge 20 in the second direction DR2. The front-end portion of the indicator 111 may be located adjacent to the grip portion 1100 in the coupled state rather than in the separated state. A distance D2 between the front-end portion of the indicator 111 and the grip portion 1100 in the coupled state may be shorter than a distance D1 between the front-end portion of the indicator 111 and the grip portion 1100 in the separated state.

Meanwhile, the coupled state of the razor cartridge 20 may include an alignment-coupled state in which the connector 220 of the razor cartridge 20 and the cartridge coupling portion 140 of the head portion 100 are perfectly coupled without misalignment, and a misalignment-coupled state in which the connector 220 of the razor cartridge 20 and the cartridge coupling portion 140 of the head portion 100 are imperfectly coupled with misalignment. The indicator 111 may indicate the alignment-coupled state and the misalignment-coupled state of the razor cartridge.

When the razor cartridge 20 and the razor handle 10 are in the misalignment-coupled state, a first side and second side of the plunger 110 spaced apart in the longitudinal direction may not slide the same distance in the first direction DR1. The position of the indicator 111 formed on the outer surface of the plunger 110 in this case may be different from the position of the indicator 111 in the alignment-coupled state. The indicator 111 in the alignment-coupled state may be symmetrical about the central axis of the plunger housing 120 or the razor handle 10 in the lengthwise direction (i.e., the y-axial direction), but the indicator 111 in the misalignment-coupled state may be asymmetrical about the central axis of the plunger housing 120 in the lengthwise direction.

Therefore, a user can check the alignment- and misalignment-coupled states between the razor cartridge 20 and the razor handle 10. When a user recognizes the misalignment-coupled state, s/he can try coupling the razor cartridge 20 and the razor handle 10 again. Details of checking whether the razor cartridge 20 and the razor handle 10 are in the alignment- or misalignment-coupled state will be described later in an alternative embodiment of the indicator 111 according to the disclosure.

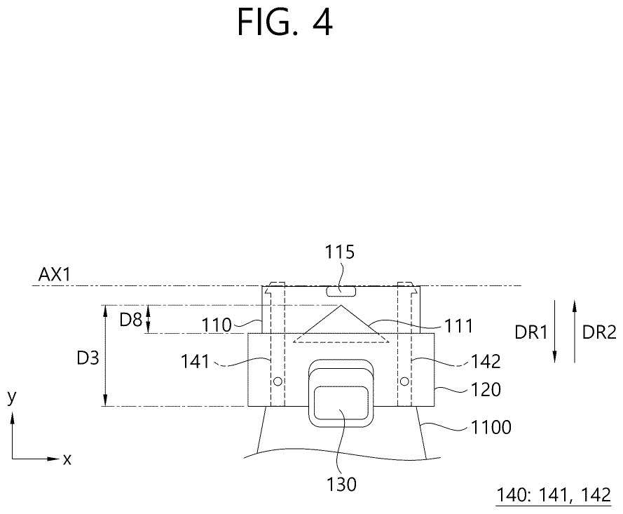

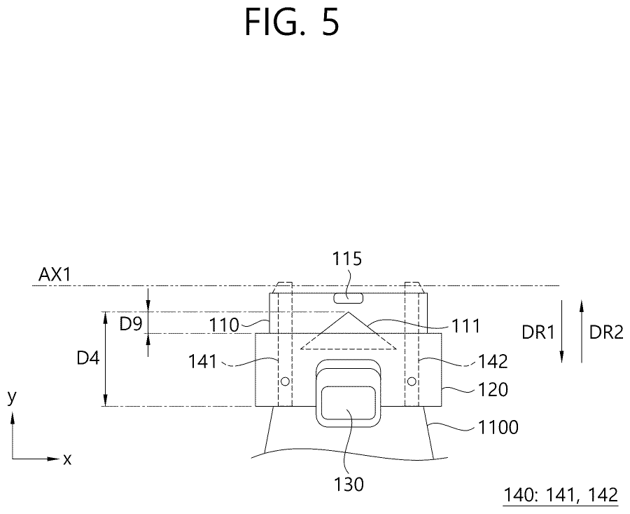

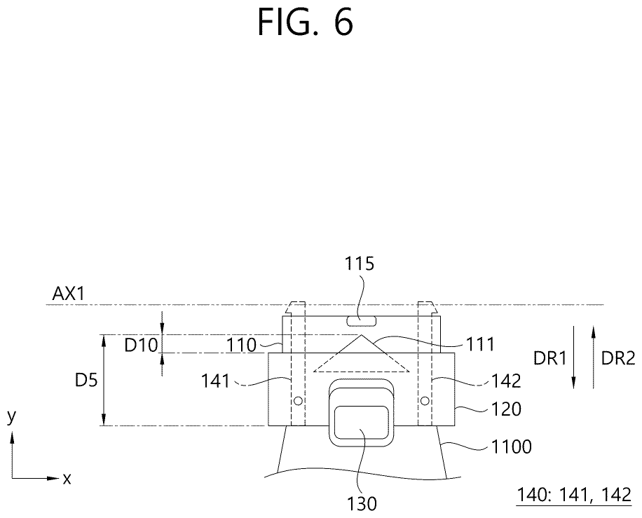

FIG. 4 is a bottom view showing a partially pivoted state of a razor handle according to an embodiment of the disclosure, FIG. 5 is a bottom view showing a further pivoted state than that of FIG. 4, and FIG. 6 is a bottom view showing a fully pivoted state of a razor handle according to an embodiment of the disclosure,

Referring to FIGS. 4 to 6, the fully pivoted state and the partially pivoted state of the razor cartridge 20 may be different from each other in the area of the indicator 111 exposed to the outside. In the fully pivoted stated, the exposed area of the indicator 111 may be minimized. The area of the indicator 111 exposed in the partially pivoted state may be larger than that in the fully pivoted state.

A user can efficiently shave by checking the exposed area of the indicator 111 reflected in a mirror during shaving and adjusting the pivot angle of the razor cartridge 20. Referring to FIGS. 4 and 5, the partially pivoted state may be divided into several states according to pivot angles. For example, the partially pivoted state may include a first partially pivoted state in which the razor cartridge 20 is pivoted at a predetermined first pivot angle from the neutral position, and a second partially pivoted state in which the razor cartridge 20 is pivoted at a second pivot angle greater than the first pivot angle from the neutral position. The area of the indicator 111 exposed in the first partially pivoted state may be larger than the area of the indicator 111 exposed in the second partially pivoted state. Therefore, a user can check the pivoted angle or pivoted state of the razor cartridge 20 through continuous increase or decrease in the area of the indicator 111.

Referring to FIGS. 4 to 6, the fully pivoted state and the partially pivoted state of the razor cartridge 20 may be different from each other in at least a portion of the exposed portion of the indicator 111.

Referring to FIGS. 4 and 5 for comparison, the first partially pivoted state (see FIG. 4) and the second partially pivoted state (see FIG. 5) are different from each other in a portion of the indicator 111 exposed to the outside. That is, a part of the indicator 111, which is exposed to the outside and adjacent to the plunger housing 120 in the first partially pivoted state, is not exposed to the outside in the second partially pivoted state.

FIGS. 4 and 5 illustrate an example in which the indicator 111 has a triangular shape as a whole. However, the part of the indicator 111, which is exposed to the outside in the first partially pivoted state but not exposed to the outside in the second partially pivoted state, may be configured to be visually distinctly distinguished from the other part (e.g., to have figural non-uniformity based on different colors, change in height/curvature, etc.) according to an embodiment so that a user can easily recognize the change in the exposed part of the indicator 111 according to the pivoted states.

Similarly, referring to FIG. 6 in comparison with FIGS. 4 and 5, the fully pivoted state (see FIG. 6), the first partially pivoted state (see FIG. 4), and the second partially pivoted state (see FIG. 5) are different from one another in the area of the indicator 111 exposed to the outside. That is, the part of the indicator 111, which is exposed to the outside and adjacent to the plunger housing 120 in the first and second partially pivoted states, is not exposed to the outside in the fully pivoted state.

FIGS. 4 to 6 illustrate an example in which the indicator 111 has a triangular shape as a whole. However, according to embodiments, the part of the indicator 111, which is exposed to the outside in the first and second partially pivoted states but not exposed to the outside in the fully pivoted state, may be configured to be visually distinctly distinguished from the other part (e.g., to have figural non-uniformity based on different colors, change in height/curvature, etc.) so that a user can easily recognize the change in the exposed part of the indicator 111 according to the pivoted states.

A user can distinguish between the fully pivoted state and partially pivoted state of the razor cartridge 20 through difference in the indicator 111 exposed to the outside. Likewise, a user can distinguish between the first partially pivoted state and the second pivoting state. Meanwhile, FIG. 6 illustrates that the indicator 111 is minimally exposed, but the indicator 111 may not be exposed to the outside at all.

Further, how far the front-end portion of the indicator 111 is adjacent to the grip portion 1100 may vary depending on the fully pivoted state and partially pivoted state of the razor cartridge 20. The front-end portion of the indicator 111 may be positioned closer to the grip portion 1100 in the fully pivoted state rather than in the partially pivoted states. Referring to FIGS. 4 to 6, a distance D5 between the front-end portion of the indicator 111 and the grip portion 1100 in the fully pivoted state may be shorter than distances D3 and D4 between the front-end portion of the indicator 111 and the grip portion 1100 in the partially pivoted states.

Further, the front-end portion of the indicator 111 may be positioned closer to the grip portion 1100 in the second partially pivoted state in which the razor cartridge 20 is pivoted at a larger angle than that in the first partially pivoted state. Referring to FIGS. 3 to 5, the distance D4 between the front-end portion of the indicator 111 and the grip portion 1100 in the second partially pivoted state may be shorter than the distance D3 between the front-end portion of the indicator 111 and the grip portion 1100 in the first partially pivoted state.

Further, the front-end portion of the indicator 111 may be positioned closer to the grip portion 1100 in the partially pivoted state rather than the neutral state. The distances D3 and D4 between the front-end portion of the indicator 111 and the grip portion 1100 in the first partially pivoted states may be shorter than the distance D2 between the front-end portion of the indicator 111 and the grip portion 1100 in the neutral state.

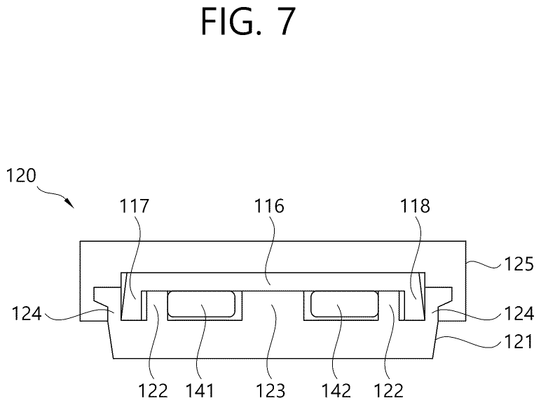

FIG. 7 is a cross-sectional view of a head portion of a razor handle according to an embodiment of the disclosure,

Referring to FIG. 7, the plunger housing 120 may slidably support the plunger 110. The plunger housing 120 may be connected to the plunger 110 of the head portion 100. The plunger housing 120 may be coupled to the head portion 100 or may be formed integrally with another configuration of the head portion 100.

When the head portion 100 further includes the plunger housing 120, the plunger 110 may include an upper wall portion 116, a first lateral wall portion 117, and a second lateral wall portion 118. The upper wall portion 116 refers to a portion where the indicator 111 is placed, and the first and second lateral wall portions 117 and 118 refer to portions extending downward from the opposite sides of the upper wall portion 116. The plunger 110 may be supported to slide by a guide lateral wall 122 of a lower housing 121 (to be described later).

The plunger housing 120 may include an upper housing 125 and the lower housing 121. The upper housing 125 and the lower housing 121 may form a space to accommodate the plunger 110 and the elastic member therein. The upper housing 125 and lower housing 121 may be coupled to each other. The lower housing 121 may include a pair of outer lateral walls 124 to form an internal space, a pair of guide lateral walls 122 to guide a sliding path of the plunger 110, and a support wall 123 to restrict rotation ranges of a first arm 141 and a second arm 142 (to be described later).

The outer wall 124 may be detachably fitted into a groove formed inside the upper housing 125. The guide lateral wall 122 may be formed to protrude being spaced apart from the outer lateral wall 124 in an inward direction. The first lateral wall portion 117 and the second lateral wall portion 118 are inserted in a pair of spaces formed between the pair of guide lateral walls 122 and the pair of outer lateral walls 124, thereby moving the plunger 110 to slide along a straight path. The support wall 123 supports the second end of the first arm 141 and the second end of the second arm 142, so that a gap between the second end of the first arm 141 and the second end of the second arm 142 may no longer narrow.

Referring to FIGS. 2 and 3, how far the front-end portion of the indicator 111 is adjacent to the front-end portion of the plunger housing 120 may vary depending on the separated and coupled states of the razor cartridge 20. The front-end portion of the plunger housing 120 refers to an end portion in the second direction DR2 facing the razor cartridge 20. The front-end portion of the indicator 111 may be positioned adjacent to the front-end portion of the plunger housing 120 in the coupled state rather than in the separated state. A distance D7 between the front-end portion of the indicator 111 and the front-end portion of the plunger housing 120 in the coupled state may be shorter than a distance D6 between the front-end portion of the indicator 111 and the front-end portion of the plunger housing 120 in the separated state.

Further, referring to FIGS. 2 and 6, the plunger 110 does not slide in the separated state, and thus the indicator 111 may be fully exposed to the outside of the plunger housing 120. On the other hand, the plunger 110 slides into the plunger housing 120 along the first direction DR1 in the fully pivoted state, and thus the indicator 111 may be at least partially accommodated in the plunger housing 120.

Further, in the separated state, the indicator 111 may be partially accommodated in the plunger housing 120, and the area of the unexposed portion of the indicator 111 may be smaller than the area of the unexposed portion of the indicator 111 in the coupled state and the pivoted state.

Referring to FIGS. 4 to 6, how far the front-end portion of the indicator 111 is adjacent to the front-end portion of the plunger housing 120 may vary depending on the fully pivoted state and the partially pivoted state of the razor cartridge 20. A distance D10 between the front-end portion of the indicator 111 and the front-end portion of the plunger housing 120 in the fully pivoted state may be shorter than distances D8 and D9 between the front-end portion of the indicator 111 and the front-end portion of the plunger housing 120 in the partially pivoted states.

The cartridge coupling part 140 may be detachably coupled to the connector 220 of the razor cartridge 20. The cartridge coupling part 140 may include a pair of first arms 141 and second arm 142 spaced apart in the longitudinal direction (i.e., the x-axial direction) in which the razor blade 230 extends. The first arm 141 and the second arm 142 may be pivoted so that the second ends thereof can move away from or close to each other in the longitudinal direction (i.e., the x-axial direction) with the first ends thereof as a central axis. As the first arm 141 and the second arm 142 are pivoted, the second ends of the first arm 141 and the second arm 142 may be partially inserted into and detached from the accommodation space of the connector 220. A coupling portion between the first arm 141 and the connector 220 and a coupling portion between the second arm 142 and the connector 220 may serve as the first rotation axis AX1 that becomes the pivot center of the razor cartridge 20.

Meanwhile, FIG. 3 shows an example in which the connector 220 is formed at a position that does not overlap with the razor blade 230. However, according to embodiments, the connector 220 may be formed on the lower surface of the razor cartridge 20 to overlap at least partially with the razor blade 230. In this case, the first rotation axis AX1 (see FIG. 3) of the razor cartridge 20 may be formed at a position different from the axis passing through the connector 220 in the longitudinal direction.

Besides the pair of first and second arms 141 and 142, a latch coupling method, a hook coupling method, etc. so that the cartridge coupling portion 140 can be detachably coupled to the connector 220 of the razor cartridge 20.

Meanwhile, FIG. 3 illustrates an example in which the cartridge coupling portion 140 including the pair of first and second arms 141 and 142 is coupled to the connector 220 fixed to the razor cartridge 20, but the disclosure is not limited to this example. For instance, the connector 220 may be coupled to the cartridge 20 and pivoted around the first rotation axis AX1, and in this case, the cartridge coupling portion 140 may be coupled to the connector by the latch coupling method, the hook coupling method, etc. rather than the method using the pair of first and second arms 141 and 142.

The operation unit 130 refer to a portion for operating the first arm 141 and the second arm 142 of the cartridge coupling portion 140. The operation unit 130 may release the coupling between the first arm 141 and the connector 220 and the coupling between the second arm 142 and the connector 220, thereby separating the razor cartridge 20 from the razor handle 10. As the operation unit 130 is moved in the first direction DR1, a distance between the second end of the first arm 141 and the second end of the second arm 142 may become narrow. As the distance between the second end of the first arm 141 and the second end of the second arm 142 becomes narrow, the second end of the first arm 141 and the second end of the second arm 142 are separated from the accommodation space of the connector 220, thereby releasing the coupling between the first arm 141 and the connector 220 and the coupling between the second arm 142 and the connector 220.

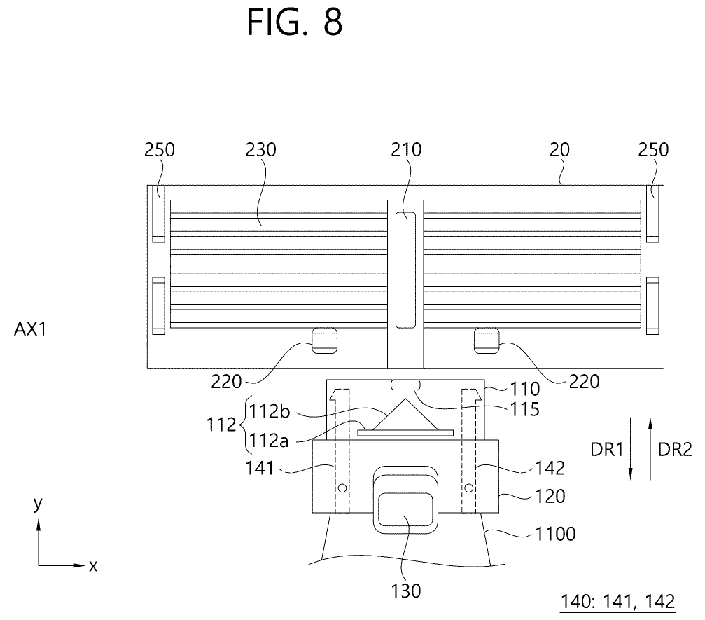

FIG. 8 is a bottom view showing an alternative embodiment of the indicator in FIG. 2. For convenience of description, the same reference numerals refer to elements similar to those of the foregoing embodiment, and repetitive descriptions thereof will be avoided.

Referring to FIG. 8, the indicator 112 may include a first part 112a and a second part 112b. The first part 112a may be formed closer to the front-end portion of the plunger housing 120 than the second part 112b, and the second part 112b may be formed closer to the razor cartridge 20 than the first part 112a. The first part 112a may be formed to have a linear shape or include a linear shape. For example, the first part 112a may be entirely or partially formed to have the linear shape long in the longitudinal direction (i.e., the x-axial direction), and the second part 112b may be formed to have a different shape from the first part 112a, such as a circle or a polygon. Alternatively, the first part 112a may entirely or partially have the same or corresponding shape as the shape of the front-end portion of the plunger housing 120.

In the separated state of the razor cartridge 20, the whole or portion of the first part 112a and the whole of the second part 112b may be exposed to the outside of the plunger housing 120.

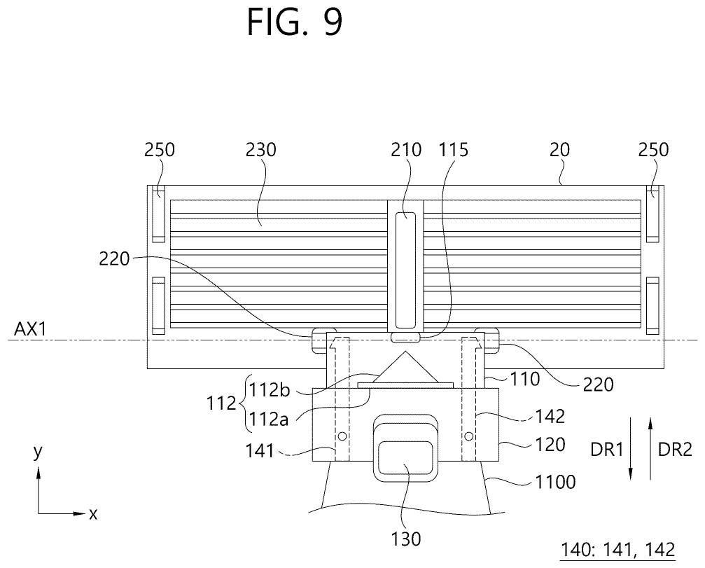

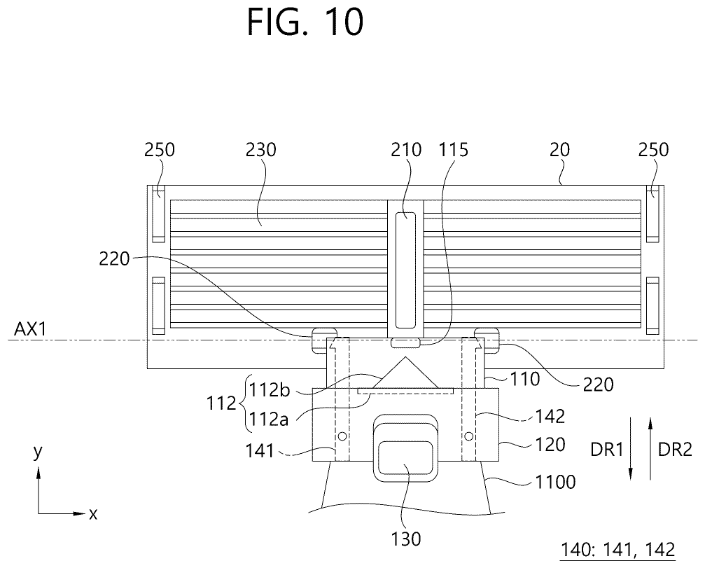

FIG. 9 is a bottom view showing a coupled state of the razor handle of FIG. 8, and FIG. 10 is a bottom view showing a coupled state different from that of FIG. 9.

Referring to FIG. 9, in the coupled state of the razor cartridge 20, the first part 112a may be at least partially positioned adjacent to the front-end portion of the plunger housing 120.

In this case, a user can recognize whether the razor cartridge 20 is normally coupled based on whether the first part 112a is positioned closer to the front-end portion of the plunger housing 120 than in the separated state.

For example, the first part 112a is positioned being spaced apart from the front-end portion of the plunger housing 120 in the separated state, but the plunger 110 moves a certain distance along the first direction DR1 during a coupling process, and the first part 112a is at least partially exposed to the outside in contact with the front-end portion of the plunger housing 120 in the normal coupled state, thereby allowing a user to recognize whether the razor cartridge 20 is normally coupled based on a relative position between the first part 112a and the plunger housing 120.

Alternatively, in both the separated state and the coupled state, the first part 112a is positioned adjacent to the front-end portion of the plunger housing 120 or the first part 112a is partially accommodated in the plunger housing 120, but the exposed area of the first part 112a in the coupled state may be smaller than the exposed area of the first part 112a in the separated state.

Further, when the first part 112a is entirely or partially formed to correspond to the shape of the front-end portion of the plunger housing 120, a user can recognize whether the razor cartridge 20 is normally coupled based on a shape matching degree between the first part 112a and the front-end portion of the plunger housing 120.

Further, referring to FIG. 9, the first part 112a is at least partially positioned adjacent to the front-end portion of the plunger housing 120 in the coupled state, and thus the plunger 111 retreats along the first direction DR1 when the rotation angle of the razor cartridge 20 increases. Therefore, the exposed area of the first part 112a gradually decreases as the rotation angle of the razor cartridge 20 increases, and the first part 112a is entirely accommodated in the plunger housing 120 when the rotation angle of the razor cartridge 20 is greater than or equal to a certain angle. For example, when the razor cartridge 20 reaches the maximum rotation angle, the first part 112a may be entirely accommodated in the plunger housing 120.

Therefore, a user can recognize how far the razor cartridge 20 is rotated based on the exposed area of the first portion 112a.

That is, the first part 112a may function as an indicator for indicating whether the razor cartridge 20 is coupled and/or an indicator for indicating how far the razor cartridge 20 is rotated. Further, the second part 112b may function as an indicator for indicating how far the razor cartridge 20 is rotated.

Meanwhile, referring to FIG. 10, in the coupled state of the razor cartridge 20, the first part 112a may be entirely accommodated in the plunger housing 120. In this case, the front-end portion of the first part 112a may be positioned adjacent to the front-end portion of the plunger housing 120.

In this case, a user can recognize whether the razor cartridge 20 is normally coupled based on whether the first part 112a is exposed.

For example, in the separated state, the first part 112a may be positioned being spaced apart from the front-end portion of the plunger housing 120, or the first part 112a may be at least partially accommodated in the plunger housing 120 so that the first part 112a can be at least partially exposed to the outside. In the coupling process, the plunger 111 moves a predetermined distance along the first direction DR1, and in the normally coupled state, the first part 112a is entirely accommodated in the plunger housing 120 and is not exposed to the outside.

Therefore, a user can recognize whether the razor cartridge 20 is normally coupled based on whether the first part 112a is exposed, and thus the first part 112a may function as the indicator for indicating whether the razor cartridge 20 is coupled and the second part 112b may function as the indicator for indicating how far the razor cartridge 20 is rotated.

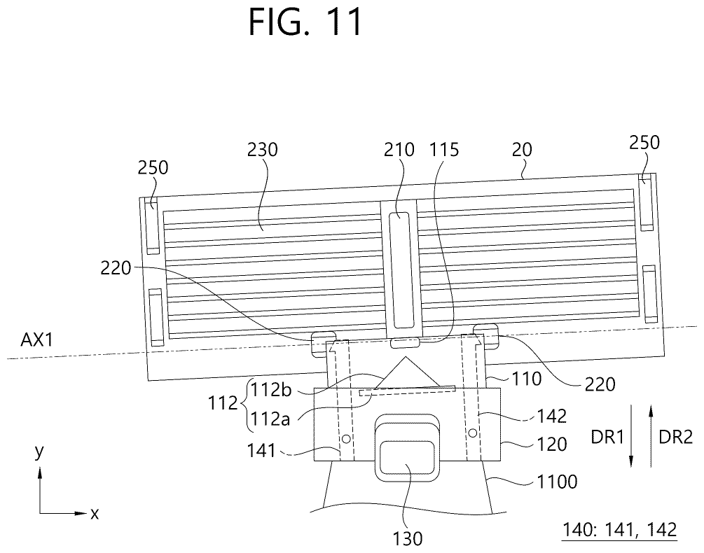

FIG. 11 is a bottom view showing a misalignment-coupled state between the razor handle and the razor cartridge of FIG. 8.

Referring to FIG. 11 along with FIG. 9 or 10, the indicator 112 may indicate whether the coupling between the razor cartridge 20 and the razor handle 10 is in an alignment-coupled state (see FIG. 9 or 10) or a misalignment-coupled state (see FIG. 11). As described above, the position of the indicator 112 may vary depending on the alignment-coupled state and the misalignment-coupled state between the razor cartridge 20 and the razor handle 10.

In the alignment-coupled state, the indicator 112 may be symmetrical in area, shape, position, etc. with respect to the longitudinal central axis of the plunger housing 120. On the other hand, in the misalignment-coupled state, the indicator 112 may be asymmetrical in area, shape, and position with respect to the longitudinal central axis of the plunger housing 120.

The indicator 112, which includes the first part 112a formed to have a straight shape or a shape corresponding to the front-end portion of the plunger housing 120, may more distinctly indicate the alignment-coupled state and the misalignment-coupled state between the razor cartridge 20 and the razor handle 10.

For example, referring to FIGS. 9, 10 and 11 for comparison, the first part 112a in the alignment-coupled state (see FIG. 9 or 10) is aligned with and longitudinally parallel to the front-end portion of the plunger housing 120, but the first part 112a in the misalignment-coupled state (see FIG. 11) is longitudinally oblique to the front-end portion of the plunger housing 120.

Therefore, a user can easily recognize the alignment-coupled state and the misalignment-coupled state between the razor cartridge 20 and the razor handle 10 based on relative alignment between the first part 112a and the front-end portion of the plunger housing 120.

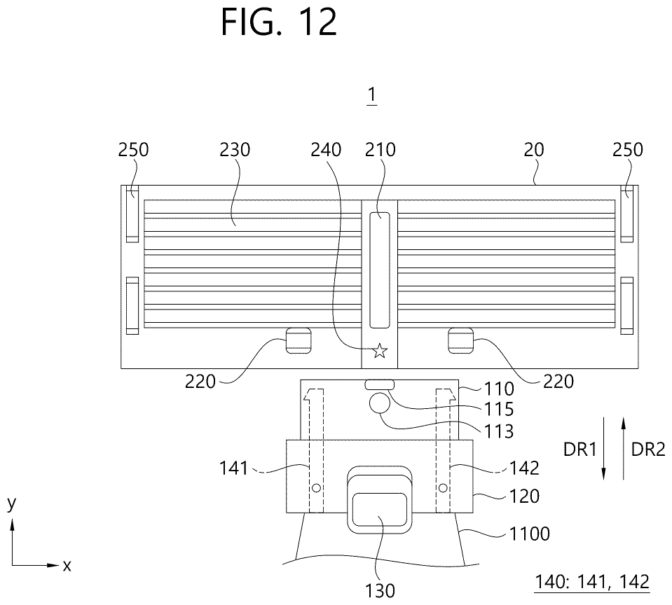

FIG. 12 is a bottom view showing a separated state of a razor assembly according to another embodiment of the disclosure. For convenience of description, the same reference numerals refer to elements similar to those of the foregoing embodiment, and repetitive descriptions thereof will be avoided.

Referring to FIG. 12, according to this embodiment of the disclosure, a razor assembly 1 includes the razor cartridge 20, and the razor handle 10.

The razor assembly 1 according to this embodiment of the disclosure is different from the razor handle 10 according to the foregoing embodiment in that a first indicator 113 is provided on the outer surface of the plunger 110 and the razor cartridge 20 includes a second indicator 240.

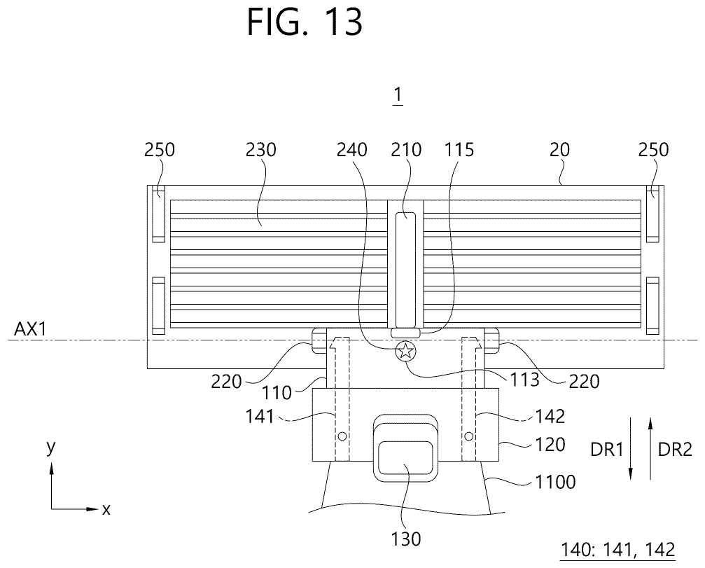

FIG. 13 is a bottom view showing a coupled state of a razor assembly according to another embodiment of the disclosure,

Referring to FIG. 13, while the razor cartridge 20 and the razor handle 10 are coupled, the second indicator 240 may be formed to overlap at least partially with the first indicator 113. For example, the first indicator 113 may be formed as a through hole having a predetermined size penetrating the plunger housing 120, and the second indicator 240 may be provided in various forms such as an engraved form, an embossed form, a sticker, and a stamp. The second indicator 240 may formed to have the same or smaller diameter as the diameter of the first indicator 113 so as to overlap the first indicator 113 in the coupled state between the razor cartridge 20 and the razor handle 10. The second indicator 240 may be formed to be positioned at the center of the first indicator 113 to indicate the alignment-coupled state in which the razor cartridge 20 and the razor handle 10 are coupled with alignment. When the razor cartridge 20 and the razor handle 10 are coupled with misalignment, the second indicator 240 may not be positioned at the center of the first indicator 113 or may be positioned at least partially outside the first indicator 113.

Further, the first indicator 113 and the second indicator 240 may inform a user of a mounting direction of the razor cartridge 20 to the razor handle 10. When the razor cartridge 20 is to be mounted to the razor handle 10, a user checks the positions of the first indicator 113 and the second indicator 240 and at the same time adjusts the mounting direction of the razor cartridge 20 to the razor handle 10 to face the first indicator 113 or the mounting direction of the razor handle 10 to the razor cartridge 20 to face the second indicator 240. A user can easily couple the razor handle 10 and the razor cartridge 20 by adjusting the mounting direction based on the first indicator 113 and the second indicator 240.

In addition, the first indicator 113 and the second indicator 240 may indicate the mounting state and a pivoting state of the razor cartridge 20. Details related to this are the same as those of the foregoing embodiment of the disclosure, and thus detailed descriptions thereof will be omitted.

However, compared to the aforementioned embodiment, this embodiment using the first indicator 113 and the second indicator 240 may allow a user to easily recognize the alignment-coupled state and the misalignment-coupled state based on whether the first indicator 113 and the second indicator 240 overlap.

Further, compared to the aforementioned embodiment, this embodiment using the first indicator 113 and the second indicator 240 may allow a user to recognize the pivoting state of the razor cartridge 20 based on the alignment state, the overlapping state, etc. between the first indicator 113 and the second indicator 240. For example, the first indicator 113 and the second indicator 240 overlap when the razor cartridge 20 is in the neutral state, and the plunger 110 retreats along the first direction DR1 as the rotation angle of the razor cartridge 20 increases, thereby allowing a user to recognize the pivoting state of the razor cartridge 20 based on how far the second indicator 240 deviates from the first indicator 113. The second indicator 240 may be configured to completely deviate from the first indicator 113 when the razor cartridge 20 is positioned at the maximum rotation angle, so that a user can easily recognize that the razor cartridge 20 reaches the maximum rotation angle.

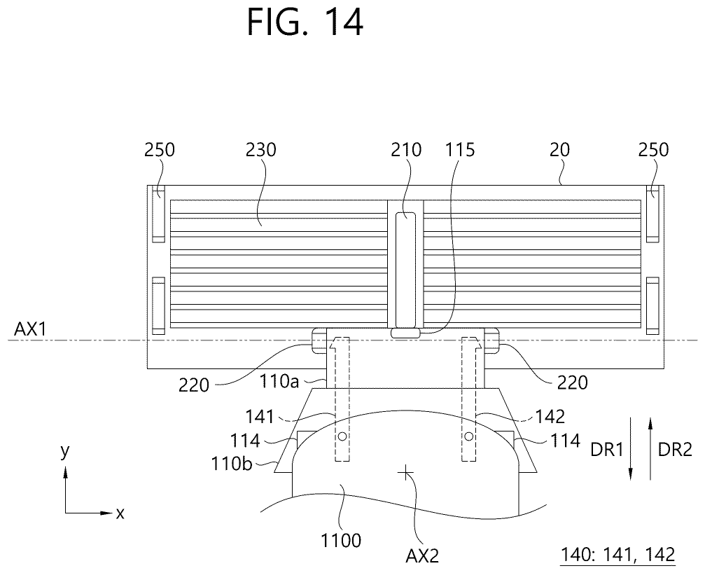

FIG. 14 is a bottom view showing a coupled state or a razor handle according to still another embodiment of the disclosure. For convenience of description, the same reference numerals refer to elements similar to those of the foregoing embodiment, and repetitive descriptions thereof will be avoided.

Referring to FIG. 14, the razor handle 10 according to this embodiment of the disclosure is different from the razor handle 10 according to the foregoing embodiment of the disclosure in including a first plunger 110a and a second plunger 110b.

The plunger 110 may include the first plunger 110a and the second plunger 110b.

The first plunger 110a may provide a restoring force for elastically supporting the razor cartridge 20 and restoring the razor cartridge 20 to the neutral position, like the plunger 110 of the aforementioned embodiment of the disclosure. The first plunger 110a may provide the restoring force to the razor cartridge 20 pivoted around the first rotation axis AX1. The second plunger 110b may provide a restoring force to the razor cartridge 20 pivoted around the second rotation axis AX2. The second rotation axis AX2 refers to an axis perpendicular to the longitudinal direction (i.e., the x-axial direction) and a transverse direction (i.e., the y-axial direction) and perpendicular to the first rotation axis AX1 while penetrating the upper and lower surfaces of the second plunger 110b. The razor cartridge 20 may be pivoted around the first rotation axis AX1 and may be pivoted left and right around the second rotation axis AX2.

The first plunger 110a may be configured to have the same structure and function as the plunger 110 according to the foregoing embodiment and another embodiment of the disclosure. Therefore, the indicators 111, 112, and 113 according to the foregoing embodiment or another embodiment of the disclosure may be provided on the outer surface of the first plunger 110a.

The second plunger 110b may be connected to the first plunger 110a and support the first plunger 110a to be slidable. The first plunger 110a and the second plunger 110b may provide the restoring force in various directions with respect to several rotation axes to the razor cartridge 20, thereby bring the razor blade 230 closer to the skin surface of a user.

On the outer surface of the second plunger 110b, an indicator 114 may be provided to indicate a state that the razor cartridge 20 is rotated left and right around the second rotation axis AX2.

The indicator 114 may be formed on the outer surface of the second plunger 110b in various forms such as an engraved form, an embossed form, a sticker, and a stamp. The indicator 114 may be formed in various shapes such as a line and a polygon that can be checked by a user, and its shape is not limited. Further, the indicator 114 may be formed to have a color different from that of the outer surface of the second plunger 110b.

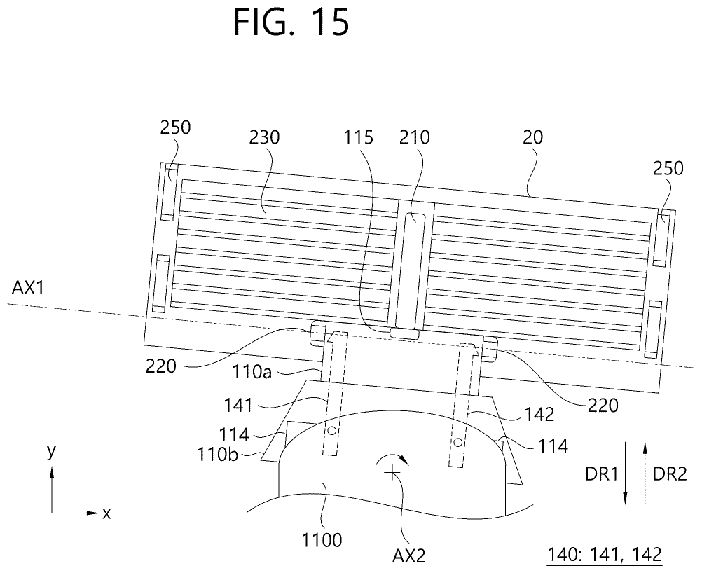

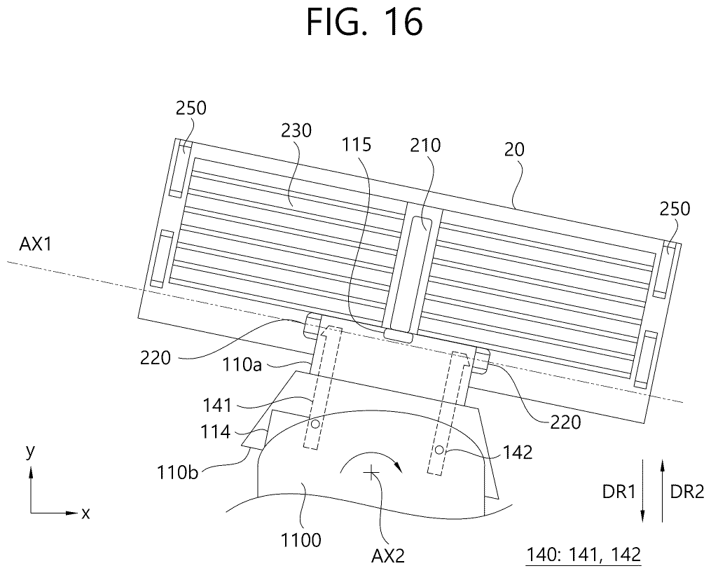

FIG. 15 is a bottom view showing a pivoting state of a second plunger of FIG. 14, and FIG. 16 is a bottom view showing a pivoting state at an angle different from that of FIG. 15.

Referring to FIG. 15, the indicator 114 may be inclined to form a predetermined angle with respect to the longitudinal direction (i.e., the x-axial direction) in proportion to the angle at which the razor cartridge 20 is rotated left and right. In order for a user to easily check an inclination degree of the indicator 114, the indicator 114 may be formed to include a straight edge parallel to the longitudinal direction (i.e., the x-axial direction).

Referring to FIGS. 15 and 16, the exposed area and at least a portion of the exposed portion of the indicator 114 may vary depending on how far the razor cartridge 20 is pivoted left and right. Accordingly, a user can efficiently perform shaving by adjusting the angle at which the razor cartridge 20 is pivoted left and right, based on the inclination degree, exposed area, and exposed portion of the indicator 114.

As described above, according to the disclosure, it is easy to check whether the razor handle 10 and the razor cartridge 20 are coupled. According to the disclosure, it is easy to check whether the razor handle 10 and the razor cartridge 20 are perfectly coupled without misalignment. According to the disclosure, it is easy to check how far the razor cartridge 20 is pivoted from the neutral position. According to the disclosure, it is easy to mount the razor cartridge 20 to the razor handle 10.

Although exemplary embodiments of the disclosure have been described with reference to the accompanying drawings, the configurations described in the embodiments and depicted in the drawings are merely the most preferred embodiments of the disclosure and do not represent all the technical ideas of the disclosure, and thus it should be understood that there may be various equivalents and variations capable of replacing the embodiments at the time of this application. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor handle coupling with a razor cartridge, comprising:
a head portion coupled to the razor cartridge; and
a grip portion extending from the head portion,
wherein the head portion comprises a plunger that provides a restoring force to elastically support the razor cartridge and restore the razor cartridge to a neutral position, and
wherein an indicator is provided on an outer surface of the plunger to indicate at least one of a mounting state and a pivoting state of the razor cartridge.

2. The razor handle of claim 1, wherein the mounting state comprises:
a separated state in which the razor cartridge is not coupled to the razor handle; and
a coupled state in which the razor cartridge is coupled to the razor handle, and
wherein an area of the indicator exposed to an outside in the coupled state is different from an area exposed to the outside in the separated state.

3. The razor handle of claim 1, wherein the mounting state comprises:
a separated state in which the razor cartridge is not coupled to the razor handle; and
a coupled state in which the razor cartridge is coupled to the razor handle, and
wherein at least a portion of a part of the indicator exposed to an outside in the coupled state is different from at least a portion of a part exposed to the outside in the separated state.

4. The razor handle of claim 1, wherein the mounting state comprises:
a separated state in which the razor cartridge is not coupled to the razor handle; and
a coupled state in which the razor cartridge is coupled to the razor handle, and
wherein a front-end portion of the indicator is positioned closer to the grip portion in the coupled state than in the separated state.

5. The razor handle of claim 1, wherein the pivoting state comprises:
a fully pivoted state in which the razor cartridge is pivoted to a maximum angle from the neutral position; and
a partially pivoted state in which the razor cartridge is pivoted to less than the maximum angle from the neutral position, and
wherein an area of the indicator exposed to an outside in the fully pivoted state is different from an area exposed to the outside in the partially pivoted state.

6. The razor handle of claim 1, wherein the pivoting state comprises:
a fully pivoted state in which the razor cartridge is pivoted to a maximum angle from the neutral position; and
a partially pivoted state in which the razor cartridge is pivoted to less than the maximum angle from the neutral position, and
wherein at least a portion of a part of the indicator exposed to an outside in the fully pivoted state is different from at least a portion of a part exposed to the outside in the partially pivoted state.

7. The razor handle of claim 1, wherein the pivoting state comprises:
a fully pivoted state in which the razor cartridge is pivoted to a maximum angle from the neutral position; and
a partially pivoted state in which the razor cartridge is pivoted to less than the maximum angle from the neutral position, and
wherein a front-end portion of the indicator is positioned closer to the grip portion in the fully pivoted state than in the partially pivoted state.

8. The razor handle of claim 7, wherein the pivoting state further comprises a neutral state in which the razor cartridge is in the neutral position, and
wherein the front-end portion of the indicator is positioned closer to the grip portion in the in the partially pivoted state than in the neutral state.

9. The razor handle of claim 1, wherein the head portion further comprises a plunger housing to support the plunger to be slidable,
wherein the mounting state comprises:
a separated state in which the razor cartridge is not coupled to the razor handle; and
a coupled state in which the razor cartridge is coupled to the razor handle, and
wherein a distance between a front-end portion of the indicator and a front-end portion of the plunger housing is shorter in the coupled state than in the separated state.

10. The razor handle of claim 9, wherein:
the indicator comprises a first part, and a second part formed closer to the front-end portion of the plunder housing than the first part,
in the separated state, the first part and the second part are exposed to the outside of the plunger housing, and
in the coupled state, at least a portion of the second part is exposed to the outside of the plunger housing, and at least a portion of the first part is accommodated in the plunger housing or positioned on the front-end portion of the plunger housing.

11. The razor handle of claim 9, wherein:
the pivoting state comprises a fully pivoted state in which the razor cartridge is pivoted to a maximum angle from the neutral position, and
the indicator is fully exposed to the outside of the plunger housing in the separated state, and at least partially accommodated in the plunger housing in the fully pivoted state.

12. The razor handle of claim 1, wherein the head portion further comprises a plunger housing to support the plunger to be slidable,
wherein the pivoting state comprises:
a fully pivoted state in which the razor cartridge is pivoted to a maximum angle from the neutral position; and
a partially pivoted state in which the razor cartridge is pivoted to less than the maximum angle from the neutral position, and
wherein a distance between a front-end portion of the indicator and a front-end portion of the plunger housing is shorter in the fully pivoted state than in the partially pivoted state.

13. A razor assembly comprising:
a razor cartridge with at least one razor blade accommodated therein, and a razor handle coupling with the razor cartridge,
wherein the razor handle comprises a plunger that provides a restoring force to elastically support the razor cartridge and restore the razor cartridge to a neutral position,
wherein a first indicator is provided on an outer surface of the plunger, and
wherein the razor cartridge comprises a second indicator at least partially overlapping the first indicator while being coupled to the razor handle.
